(19) United States
(12) Patent Application Publication
(10) Pub. No.: US 2013/0219973 A1
(43) Pub. Date: Aug. 29, 2013

(54) Combination Padlock With Revolving Cover

(71) Applicants: Zhongwei Cao, Ningbo (CN); Jun Hu, Ningbo (CN)

(72) Inventors: Zhongwei Cao, Ningbo (CN); Jun Hu, Ningbo (CN)

(73) Assignee: NINGBO YONGFA GROUP CO., LTD.,, Ningbo, Zhejiang (CN)

(21) Appl. No.: 13/148,096

(22) PCT Filed: Jun. 11, 2010
(86) PCT No.: PCT/CN2010/000832

§ 371 Date: Aug. 5, 2011

(30) Foreign Application Priority Data
Oct. 26, 2009 (CN) 200910174978.9

(51) Int. Cl. E05B 67/38

(52) U.S. Cl. CPC E05B 67/38
USPC 70/21; 70/22

(57) ABSTRACT

A combination padlock with revolving cover having a baseplate having an upper side, a lower side, a front side, a keypad on the front side, and a pillar formed on the front side. A revolving cover of a basically same contour as the baseplate has a rear face contacting the front side of the baseplate, a front face, a round opening, and an arc groove defined in the rear face thereof. A central cap has a side wall received in the round opening of the revolving cover and fixed to the baseplate, and a peripheral covering and resting on the front face of the revolving cover.

### CROSS-REFERENCE TO RELATED APPLICATIONS

This patent application claims the priority of the Chinese patent application No. 200910174978.9 filed on Oct. 26, 2009, which application is incorporated herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a combination padlock, and more particularly, to a combination padlock with a baseplate and a revolving cover thereon.

2. Description of Related Art

There are various electronic safes available in current market. For such safes, electronically coded lock panel is a part of most important. The panels usually have a baseplate with a keyboard provided thereon. Some may further have a keyhole defined therein and/or a display panel provided for indicating time, date, and/or digitals.

A Chinese utility model patent ZL200720113421.0 “A Lock Panel For Safes” teaches a lock panel having a baseplate with a keyboard and a keyhole. The baseplate has a slidable cover which is able to cover a keyhole thereof. A guiding rail is provided on an inner and an lower part of the slidable cover and corresponding guiding grooves are defined in the baseplate. The guiding rail is slidably received in the guiding grooves making the slidable cover horizontally move with respect to the guiding grooves. A limiter may be provided between the baseplate and the slidable cover. An improvement of this conventional lock panel is that the slidable cover is able to freely move with respect to the baseplate and to close and/or open the keyhole. It increase the concealment of the keyhole with a simple structure.

However, the lock panel of most conventional combination padlocks has a bared keyboard, which makes the keyboard vulnerable to dust, pollution, and/or collisions. A polluted keyboard may pollute a user's finger in turn. Furthermore, a bared keyboard may negatively affect the aesthetic feeling of the whole lock panel.

Therefore, an improvement might be made on the conventional lock panels.

### BRIEF SUMMARY OF THE INVENTION

The main object of the invention is to provide a combination padlock with a revolving cover which is able to conceal and reveal a keypad thereof.

To achieve above object, the invention provides a combination padlock with revolving cover having a baseplate, a revolving cover of a basically same contour as the baseplate, and a central cap. The baseplate has an upper side, a lower side, a front side, a keypad on the front side, and a pillar formed on the front side. The revolving cover has a rear face contacting the front side of the baseplate, a front face, a round opening, and an arc groove defined in the rear face thereof. The central cap has a side wall received in the round opening of the revolving cover and fixed to the baseplate, and a peripheral covering and resting on the front face of the revolving cover.

According to one aspect of the invention, the combination padlock may further has a display installed on the baseplate and a window defined in the central cap through which the display is able to be viewed.

According to another aspect of the invention, the combination padlock may further has a plurality of peripheral dents defined in the rear face of the revolving cover and at least one peripheral damping unit installed on the front side of the baseplate. Each peripheral damping unit has a seat and at least one spring plate having one end fixed to the seat and a free end having a protrusion partially receivable in one of the peripheral dent.

According to yet another aspect of the invention, the display is controlled by a reed switch on the front side of the baseplate and a magnet on the rear face of the revolving cover. The reed switch powers on said display when the magnet approaches and power off the display when the magnet leaves.

According to still yet another aspect of the invention, a keyhole is defined in the baseplate over upon which a sliding cover is provided for concealing and revealing the keyhole.

It could be seen from the invention, with the user friendly operable revolving cover, which is able to conceal or reveal the keypad of the combination padlock, the keypad will be able to be kept from dust, pollution, and/or collisions. The aesthetic feeling of the whole combination padlock has also been improved.

### BRIEF DESCRIPTION OF THE SEVERAL VIEWS OF THE DRAWINGS

FIG. 1 is a schematic top view of the preferred embodiment of a combination padlock of the invention.

FIG. 2 is a top partially cross-sectional view thereof when a revolving cover is rotated to conceal.

FIG. 3 is a bottom partially cross-sectional view thereof.

FIG. 4 is a side cross-sectional view thereof.

FIG. 5 is another top partially cross-sectional view thereof when the revolving cover is rotated to reveal.

FIG. 6 is another bottom partially cross-sectional view thereof when the revolving cover is rotated to reveal. And,

FIG. 7 is a perspective exploded view thereof.

### DETAILED DESCRIPTION OF THE INVENTION

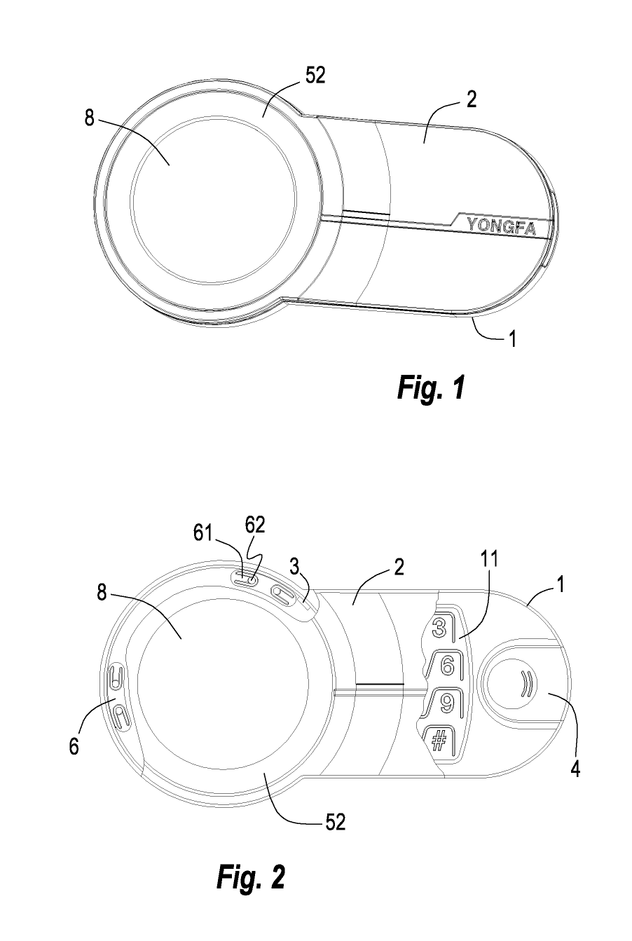

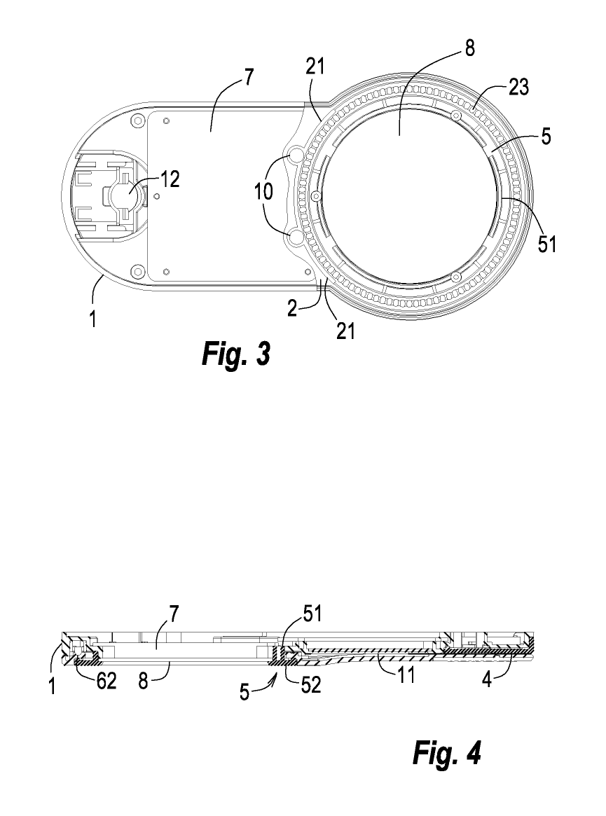

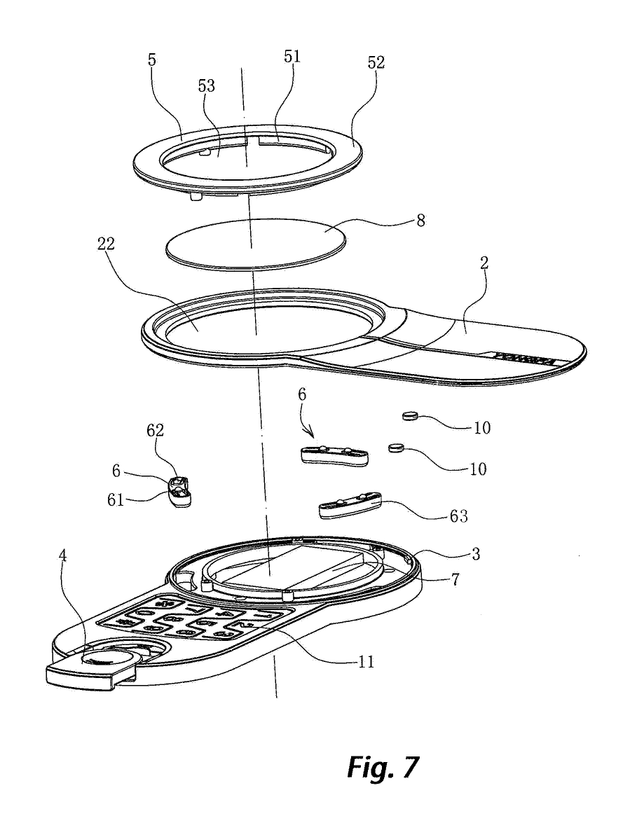

Shown in FIGS. 1 through 7 is the preferred embodiment of a combination padlock with revolving cover of the invention.

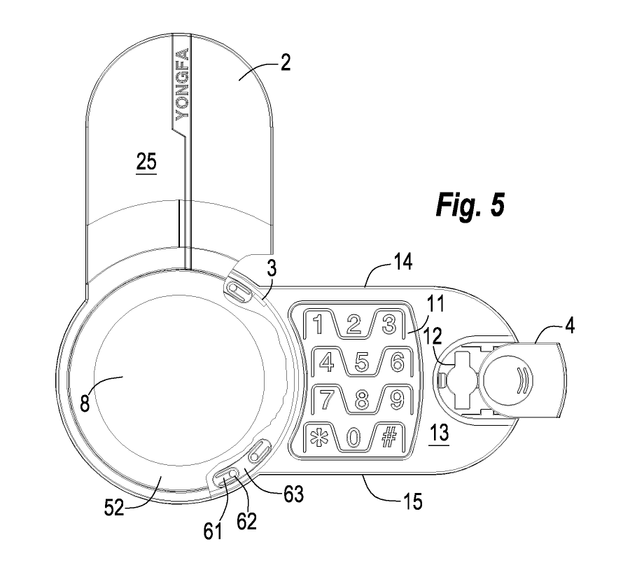

The combination padlock has a baseplate 1 with a keypad 11 on a front side 13 thereof and a revolving cover 2 having a rear face 24 contacting the front side 13 of the baseplate 1 and a front face 25. The revolving cover 2 is able to conceal and reveal the keypad 11. The keypad 11 and the revolving cover 2 have a basically same contour and all have a basically round end. As particularly shown in FIG. 5, the baseplate 1 has an upper side 14 which stays upward when a safe applying the combination padlock of the invention stands on ground in actual use and an opposite lower side 15.

The revolving cover 2 has a round opening 22 through which a central cap 5 passes from the front face 25 to the rear face 24 of the revolving cover 2 and rotatably fixes the revolving cover 2 to the baseplate 1. The central cap 5 has a side wall 51 being receivable in the round opening 22 and a peripheral 52 covering and resting on the front face 25 of the revolving cover 2 around the round opening 22. The side wall 51 is fixed to the baseplate 1 with a plurality of screws. The revolving cover 2, sandwiched between the peripheral 52 and the baseplate 1, then will be able to revolve with respect to the baseplate 1 round the central cap 5.

A revolving limit device is provided between the baseplate 1 and the revolving cover 2 for limiting the revolving movement of the revolving cover 2 between a conceal position at which the revolving cover 2 totally overlaps the baseplate 1 and a reveal position at which the revolving cover 2 basically upright with respect to the baseplate 1. The revolving limit device has a pillar 3 formed on the front side 13 of the baseplate 1 and an arc groove 21 defined in the rear face 24 of the revolving cover 2. The arc groove 21 is about 90 degree. When the revolving cover 2 revolves, the arc groove 21 rotates with the pillar 3 received therein. The revolving cover 2 is able to be rotated until either of two ends of the arc groove 21 meets the pillar 3 and is stopped thereby.

A damper is provided between the baseplate 1 and the revolving cover 2. The damper has a plurality of peripheral dents 23 defined in the rear face 24 of the revolving cover 2 and at least one, in this preferred embodiment three, peripheral damping unit 6 installed on the front side 13 of the baseplate 1. Each damping unit 6 has a seat 63 and at least one, in this preferred embodiment two, spring plate 61 having one end securely fixed to the seat 63 and a free end having a protrusion 62. Each protrusion 62 is able to engage with, by being partially received in, one of the plurality of peripheral dents 23 under a biasing force from the spring plate 61.

The combination padlock further has a display 7 installed on the baseplate 1 and a glass panel 8 sandwiched between the peripheral 52 of the central cap 5 and the front face 25 of the revolving cover 2. A window 53 is defined in the central cap 5 through which the display 7 is able to be watched via the glass panel 8.

The display 7 is controlled by a reed switch 9 installed on the front side 13 of the baseplate 1 and at least one, in this preferred embodiment two, magnet 10 installed on the rear face 24 of the revolving cover 2. The reed switch 9 and the magnet 10 are so arranged that when the revolving cover 2 is rotated to the reveal position, the magnet 10 approaches the reed switch 9 to power on the display 7 and when the revolving cover 2 is rotated to the conceal position, the magnet 10 leaves the reed switch 9 to power off the display 7.

In the baseplate 1, a keyhole 12 is defined over upon which a sliding cover 4 is provided for concealing and/or revealing the keyhole 12.

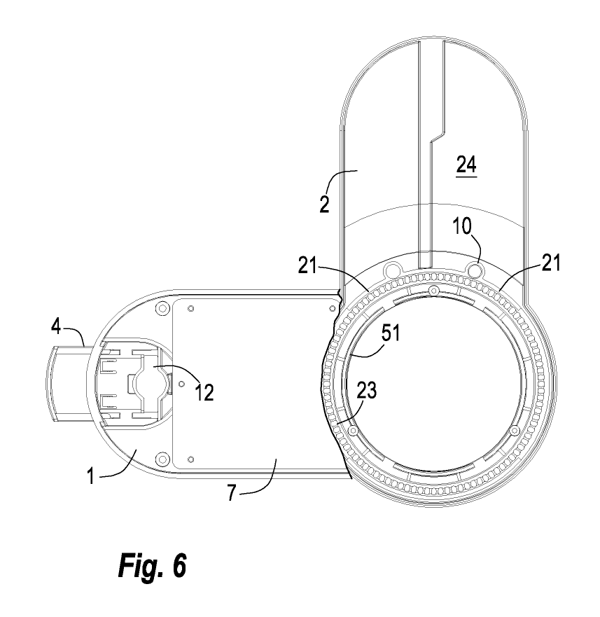

With reference particularly to FIGS. 5 and 6, in use, a user is able to rotate the revolving cover 2 upward in a direction from the lower side 15 to the upper side 14 of the baseplate 1. In the rotation, the protrusions 62 leave the peripheral dents 23 they engage. When the revolving cover 2 rotates about 90 degrees to the reveal position, one end of the arc groove 21 meets the pillar 3 and is stopped thereby. The protrusions 62 engage to new corresponding peripheral dents 23 and the revolving cover 2 is thereby hold on to the position by the damper. The magnet 10 approaches the reed switch 9 and the display 7 is powered on. The user is also able to move the sliding cover 4 aside to reveal the keyhole 12.

A reverse operation is able to close the revolving cover 2 to conceal the keypad 11. In this operation, the other end of the arc groove 21 meets the pillar 3 and is stopped thereby and the magnet 10 leaves the reed switch 9 to power off the display 7. The revolving cover 2 totally overlaps the baseplate 1 at this conceal position, as particularly shown in FIGS. 1 through 4.

1. A combination padlock with revolving cover comprising:
a baseplate having an upper side, a lower side, a front side, a keypad on said front side, and a pillar formed on said front side;
a revolving cover of a basically same contour as said baseplate, having a rear face contacting said front side of said baseplate, a front face, a round opening, and an arc groove defined in said rear face thereof; and,
a central cap having a side wall received in said round opening of said revolving cover and fixed to said baseplate, and a peripheral covering and resting on said front face of said revolving cover.

2. The combination padlock with revolving cover as claimed in claim 1, wherein a display is installed on said baseplate and a window is defined in said central cap through which said display is viewable.

3. The combination padlock with revolving cover as claimed in claim 2, wherein a glass panel is sandwiched between said peripheral of said central cap and said front face of said revolving cover.

4. The combination padlock with revolving cover as claimed in claim 1, wherein a plurality of peripheral dents are defined in said rear face of said revolving cover and at least one peripheral damping unit is installed on said front side of said baseplate, each peripheral damping unit having a seat and at least one spring plate having one end fixed to said seat and a free end having a protrusion partially receivable in one of said peripheral dent.

5. The combination padlock with revolving cover as claimed in claim 2, wherein a plurality of peripheral dents are defined in said rear face of said revolving cover and at least one peripheral damping unit is installed on said front side of said baseplate, each peripheral damping unit having a seat and at least one spring plate having one end fixed to said seat and a free end having a protrusion partially receivable in one of said peripheral dent.

6. The combination padlock with revolving cover as claimed in claim 3, wherein a plurality of peripheral dents are defined in said rear face of said revolving cover and at least one peripheral damping unit is installed on said front side of said baseplate, each peripheral damping unit having a seat and at least one spring plate having one end fixed to said seat and a free end having a protrusion partially receivable in one of said peripheral dent.

7. The combination padlock with revolving cover as claimed in claim 3, wherein said display is controlled by a reed switch on said front side of said baseplate and a magnet on said rear face of said revolving cover, and wherein said reed switch powers on said display when said magnet approaches and power off said display when said magnet leaves.

8. The combination padlock with revolving cover as claimed in claim 6, wherein said display is controlled by a reed switch on said front side of said baseplate and a magnet on said rear face of said revolving cover, and wherein said reed switch powers on said display when said magnet approaches and power off said display when said magnet leaves.

9. The combination padlock with revolving cover as claimed in claim 1, wherein a keyhole is defined in said baseplate over upon which a sliding cover is provided for concealing and revealing said keyhole.
